(19) United States
(12) Patent Application Publication
(10) Pub. No.: US 2013/0227271 A1
(43) Pub. Date: Aug. 29, 2013

(54) METHOD FOR DISTRIBUTING DIGITAL DOCUMENTS TO WHICH USER RIGHTS ARE ATTACHED, WHICH SUPPORT MULTIPLE COPYING, EXCHANGE, AND MULTIPLE PLATFORMS

(71) Applicant: Noel Pampagnin, Joinville Le Pont (FR)

(72) Inventor: Noel Pampagnin, Joinville Le Pont (FR)

(21) Appl. No.: 13/880,813

(22) PCT Filed: Oct. 20, 2011
(86) PCT No.: PCT/FR11/00563

§ 371 Date: Apr. 22, 2013

(30) Foreign Application Priority Data
Oct. 20, 2010 (FR) 10/04104

(51) Int. Cl. G06F 21/10

(52) U.S. Cl. CPC G06F 21/10
USPC 713/150; 709/202

(57) ABSTRACT

A method and system for distributing digital documents ensures security by encrypting pages, element by element, when the document is downloaded onto a terminal. After the document (w20) is opened in a console, reading begins by activating an initialization request containing a single document identifier (id1, id2) to a control server (w21), which returns a ticket containing current rights associated with the single identifier (w25, w26, w27, w22). When the current rights allow reading, the end of loading each XHTML page triggers requests for decryption, sending the encrypted elements to the control server, which returns decrypted elements unscrambled. The multimedia contents are encrypted by a key generated by the control server or are filtered by a transformation matrix. Due to an encrypted cache within the console, the document can be restored, in partially or permanently disconnected mode, by storing the decrypted elements in a crypted cache onto a terminal.

This invention relates to a process for distributing digital documents to which user rights are attached.

What is meant by user right is a right that in particular gives authorization for copying, authorization for consulting in entirety or page by page with regard to documents of the graphic and/or character type, for receiving short extracts for sound or visual documents, for a given or unlimited period.

The invention relates to a system using said process and a publishing document obtained by said process.

### TECHNICAL FIELD OF THE INVENTION

The invention relates to the field of the general processes for controlling the distribution of the digital contents, particularly PDF documents, digital books in the “EPUB” format, and multimedia documents to prevent illicit use, particularly those that disregard intellectual property rights, when the contents are distributed by a telecommunications network, or by any other means such as CD-ROMs or USB keys.

Publishers and writers wish to promote their works in digital format, because this format is easy to produce and reproduce, therefore less expensive than the printed book. However, they want to be protected against illegal copies, which cut into their sales. Solutions exist, but they have the drawback of blocking a user on a terminal, indeed three terminals with the authorization of the distributor. In addition to that, said user does not have the right to private copies.

### PRIOR ART

In the patent document WO 2007/135281, a general process for security of digital works is described that makes possible unlimited private copying, on any type of terminal satisfying prerequisites, consisting in including a supervision agent in the digital document, having as a function to authorize access to the document as a function of the current rights for said document, stored in a remote database that is accessible by public or private network. Each content delivered contains a unique identifier, which is copied again in all of the copies of said content, this unique identifier providing access to the user rights of the content.

In the patent document FR 2929024, an online bookstore is described that distributes contents of all types, controlled as to their use. The control process is an improvement of the device described in the application WO 2007/135281. It is improved by the encryption or the prior concealing of the content to be distributed, this content being made visible and comprehensible thanks to an internal program, only when the current rights stored in the remote database allow it. Such a document controls its own display in the programmable displays such as browsers (for example, Internet Explorer, Mozilla Firefox, etc.), or others (Acrobat Reader, runtimes Flash or SilverLight).

In the French patent application No. FR 2 929 024, the distinction is made between the “smart” contents that can contain a supervision agent such as a program or scripts, and the “passive” contents that cannot, such as images or music. In this latter case, the passive contents are included in an object that is itself programmable.

These processes, in addition to the unlimited and multiple-platform private copying, have the advantage of making possible the exchange and of being more flexible than the other solutions. The flexibility covers the dynamic character (for example, in connected mode, it is possible to prohibit the rendering of works already distributed at any moment) and the variety of the rights accorded to the documents: reading occurrence, end date, consulting period, assignment to a person, to an establishment, fixed or roving distribution, and, more generally, any type of right that can be modeled in a database of digital rights. These rights are part of the general environment of the digital work, in the same way as the management parameters: sales price, copyright, publication date, etc.

They are also less costly, since they are simpler to produce and to publish, because they rely on a model that separates the content of the user rights. In the model described in the application WO 2007/135281, especially intended for digital uses, an object is defined (in the programming sense of the term) in which the “license” is stored remotely in a remote database that is accessible everywhere, that can be shared between the various copies of a work thanks to a unique identifier, and that can be accessed by each copy thanks to a software device (the supervission agent) that is integrated into said copy. In contrast with existing systems, the published document is inviolable regardless of its use. However, only the script of a control server that verifies the rights and that returns a positive or negative acknowledgment to the document depending on the current rights must be adapted to the uses, the supervisor of the document processing only the alternative: positive or negative acknowledgment. The “smart” document is placed at the center of the publishing system and governs itself by the properties that are attached to it, avoiding the individualization of the document for a given person, characterized by a pair of keys of a public key infrastructure, but generalizing the individualization to the whole constraints.

In the existing systems, the publishing begins by the identification of the purchaser and continues through a string of processes ending at an encrypted document for this unique owner (document completely individualized for this customer). In the proposed system, the purchaser appears as owner of the document in the database of rights, at the same level as the other constraints.

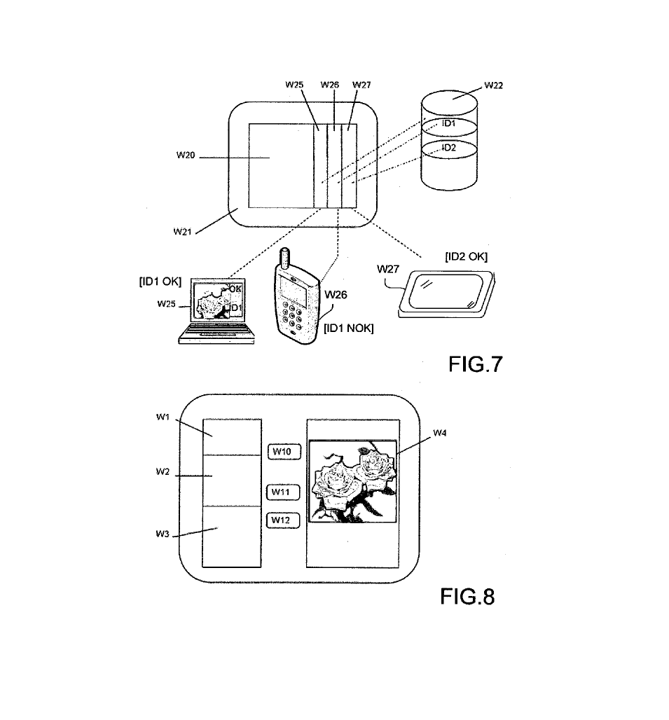

It is then possible to avoid producing a copy for each purchaser, individualized once and for all at the delivery, but to construct the generic copy that is the same for any request, the individualization at delivery dealing with all of the constraints and verified by the control script executed on the control server. In fact, it is possible to describe the digital document of the model as a smart content with which are associated execution contexts that manage, among other things, the user rights, and if all of the consequences are drawn from it, such as a re-entrant programming object, see FIG. 7, where three users W25, W26, and W27 equipped respectively with a computer, a telephone and a touch tablet, read or want to read the same generic document. W25 and W26 share the same instance of the document (they have the same identifier ID1 and the same context in the rights database W22), and W27 reads a different instance referenced by ID2. The control program W20 executed on the control server W21 manages the three contexts. W25 and W26 are restricted by a maximum number of consultations per day. W25 has access to the document [ID1, OK]. This number being exceeded, W26 cannot access the document [ID1, NOK]. W27 having independently acquired a reading right of two hours has access to the document [ID2, OK].

Resorting to public key infrastructure (PKI) to encrypt the passive documents in regard to a given terminal, where the certificate containing said private key is installed in a secure fashion by the delivery server, which is a cause of inflexibility, will also be avoided. In this application, the enciphering is achieved with a symmetric key, in regard to the generic document, for example in AES.

This process functions connected to a rights database and suits any type of “digital” consumption under constraints, particularly the sale by downloading of contents under license, the renting, the renting with option to buy, the time-related consulting, the “pay-per-view,” the online flip-paging, the consulting of reference works, the online business notes, etc.

The process also authorizes the certification of sources by signature and the right of withdrawal when a published document must be withdrawn, for example by the zeroizing of the time-limit for consulting of the published copies.

New needs are created relating to the reading of newspapers, books, listening to music, visual displaying of films, for which a “disconnected” or “partially connected” consulting mode is required for documents of all types.

### OBJECT OF THE INVENTION

This application proposes solutions that in large measure are going to meet these needs.

### SUMMARY OF THE INVENTION

The application WO 2007/135281 describes the general model for a “smart” digital document and indicates how to render it multiple-platform, exchangeable and not sensitive to multiple copying. The French patent document No. FR 2 929 024 describes the publishing system and the life cycle of such documents. It also describes the tools that complete the model for the “passive” (not “smart”) documents by the inclusion in programmable containers or by delegating to a container (what makes a pdf document contained in a browser). It also describes the means for consulting the works in disconnected mode by the management of an “open ticket” that recovers the current rights and that can be consulted when the rights database is inaccessible.

To isolate the environment for recovering documents and to keep it from non-authorized process attacks, the latter are rendered in a console of technology suited to the applications that run in browsers or on the desktop (widget).

The passive objects that it contains or that it references (MP3, JPEG, FLV, etc.) are encrypted with a console key in AES or the equivalent, with generating of the key from a “hash” of the content and from an alea depending on the rules of the art.

This document describes the application of the model to the current uses for the main digital formats and uses:
Temporary online consulting, with, for example, a “flip-paging” of digital books as an example.
Downloading of digital works, music and video, backup and recovery on the receiving terminals in connected, partially connected, and disconnected modes.
Recovery of embedded digital works.
Downloading and backup of books in the “EPUB” format, and recovery in connected, partially connected, and disconnected modes.

### DETAILED DESCRIPTION OF THE INVENTION

The following description accompanied by the attached drawings, the entirety given by way of non-limiting example, will make it well understood how the invention can be implemented.

In the drawings:

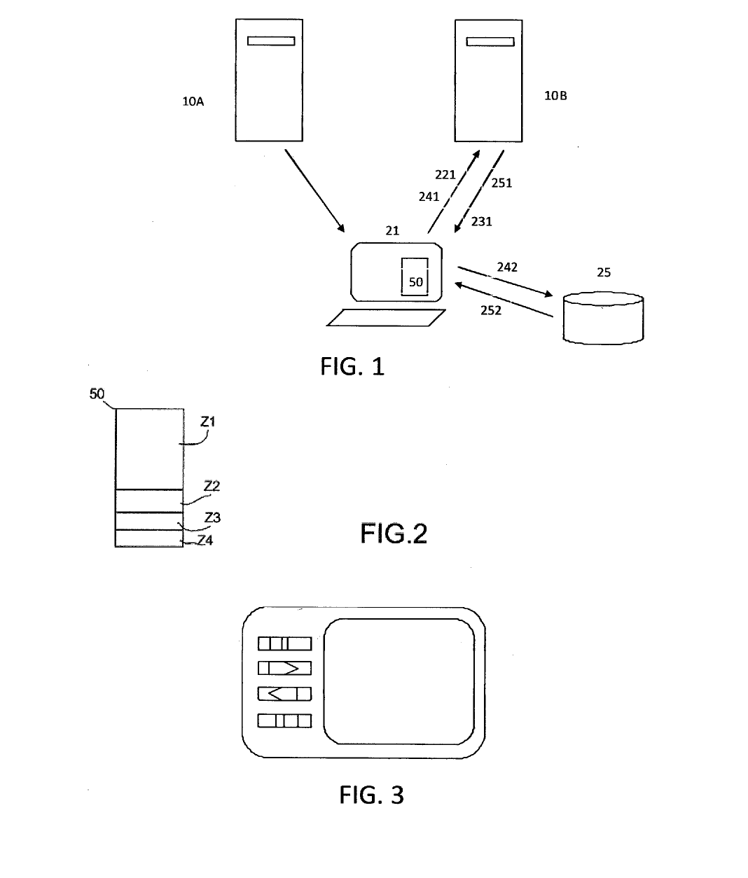

FIG. 1 shows the system of the invention.

FIG. 2 makes explicit the structure of the container.

FIG. 3 shows an overview of a multimedia reader created by a document being displayed on a terminal of a customer.

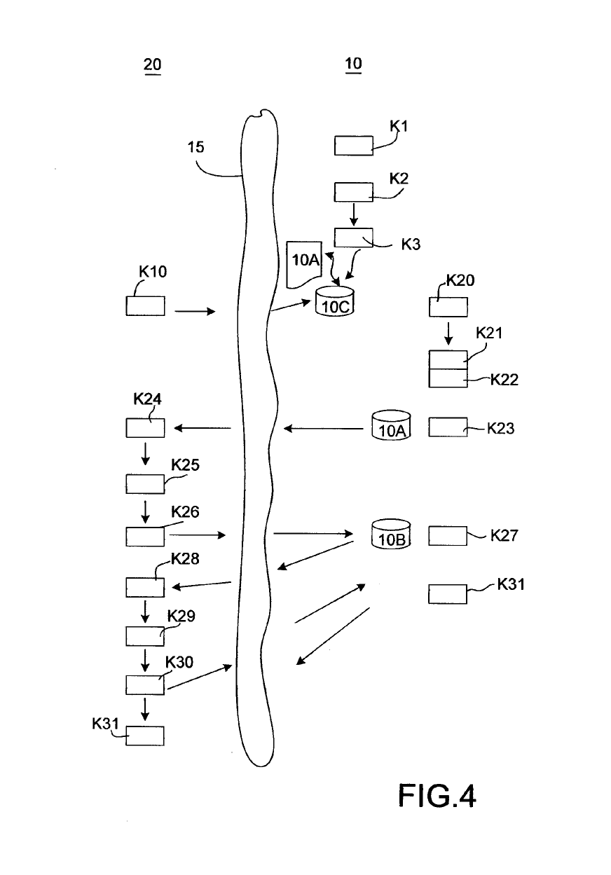

FIGS. 4 to 6 make explicit the processes used in the invention.

FIG. 7 discloses the structure of a re-entrant document.

FIG. 8 diagrammatically represents a console according to the process.

In FIG. 1, a system for the distribution of a digital document according to the invention is shown very diagrammatically. This system causes a server 10 to intervene that can have several functions, among them in particular an “order/delivery server” function 10A that concerns the processing of the document to be distributed and a “control server” function 10B that manages the authorizations of use and the consistency of the different identification codes and also a publishing server 10C. The customers can access this document by using, for example, a computer 20, or a customer terminal and by borrowing the communications means that the Internet network 15 offers. Other computers referenced indiscriminately by 50 can also access the server 10.

Other examples of embodiment of the invention can be obtained by consulting the above-mentioned patent application FR 2 929 024 that contains the application to an online bookstore.

The documents processed for a distribution have a structure 50 as shown in FIG. 2. It is made of several zones and constitutes a container for the digital document that is placed in the zone Z1. The zone Z2 relates to the active codes of the script type that use stages of the process of the invention. The zone Z3 is assigned to a unique identifier code assigned to the document. The zone Z4 contains the name of the issuer of the document and also a signature of the entire container so that a modification of the latter brings about an invalidation of the signature that makes it possible to detect a criminal maneuver.

This invention is based on processes of the previously cited prior art, and to which the invention proposes improvements to be applied to the passive formats included in XHTML programmable pages and derivatives, particularly the EPUB format of the digital book.

The invention is applied to the multimedia objects included in the XHTML pages. It is possible to recover the contents, not only in a mode connected to the rights database, but also in partially disconnected mode and total disconnected mode. Ultimately, the invention presents a new service for renting contents with option to buy, the consumer being able to transform his limited consulting rights over time into permanent rights on several machines of his choice.

The invention takes advantage of the availability of the client technologies of the WEB browsers in applications that are run on the desktop from the computer of the customer 20 and that have extended rights, such as access to the system of local files (technologies of “widgets”).

It should be noted that it is assumed that the servers for order/delivery 10A, for control 10B and for publishing 10C are impervious to the attacks of unauthorized persons, who cannot reach the storage units of the reference documents, nor the rights databases. To do this, the protection means of the servers are used in accordance with the state of the art.

The protections rely in general on the encryption of the objects with “keys.” Symmetric “generic encryption system” having recourse to keys (and/or passphrases), which can be generated by various methods, suited to the objects and procedures to be protected (AES, MD5, SHA, etc.) should thereby be understood in this document. Since the document is not attached to a declared entity, it is possible to encrypt the documents and the exchanges in AES, instead of RSA, which makes it possible to avoid the inflexibility, the sluggishness and the cost of the management of the RSA keys. The only essential RSA key is the one that authenticates the delivery server of the distributor during the signing of the documents that are issued.

This description is a general model, based on standardized technologies such as JavaScript and/or proprietary technologies of various origins such as AIR of Adobe, Silverlight of Microsoft, HTML5, Opera widget of Opera Software, etc. Whenever possible, the explanations will be given in JavaScript for clarity, but the implementations in proprietary solutions are broader and more robust, because the JavaScript scripts are public. Likewise, the examples of server scripts are given in PHP because this is a public language accessible to everyone, but the equivalent proprietary solutions still exist.

Certain external functions assigned by the model are not described beyond the service that they render. These functions fall within the competence of proprietary implementation.

Other low-level functions in the stack of services are lacking in certain editors, or remain to be developed. They will be indicated as such in the description.

### 1—THE CONSOLE (FIG. 3)

To ensure a checking of the rights associated with the documents, which withstand an attack by somewhat substantial lawbreakers, it is wise to limit the points of attack by performing the recovery of the documents in a protected framework. This is the objective of the “console,” a software device, which is built according to the technologies of the WEB applications, outside of the WEB, and “widgets.”

The console is also a local library, which has as its function to reference the contents purchased by a customer, and to present them to said customer. The selection of a document activates the recovery procedure. In addition, the console provides the encryption-decryption services of the exchanges with the control server.

The console is signed by the distributor; his copies are optionally known and recorded by the control server, following an initializing that takes place during the installation of the software device. The initial dialog of the installation of the console on a terminal begins by the sending to the delivery server of the unique identity of the software device of the console guaranteed by a third party, the editor of the execution engine used (the “runtime”). It results in the returning by the delivery server of a string of characters, which is the unique identity of the console, that the console stores in its private encrypted local memory, or in an equivalent device that makes it possible to ensure the permanence and integrity of the identity of the software device. From its identity and from the unique identifier of the software device, the console key required by the symmetric encryption is generated, according to the rules of the art. At the end of initializing, this console key is recorded by the delivery server with the identity of the console.

During exchanges with the server, the console, in a version of this invention, sends its personal identity accompanied by the desired parameters encrypted in AES with its own key to authenticate its requests to the control server, to prevent spoofing by unwanted software devices. This version is described below.

In another version, the supervisor of the document verifies the authenticity of the console, during requests to the control server, by the call to the propriarity function that returns the unique identity of the application.

### 2—XML DOCUMENTS, IMAGES, SOUNDS AND VIDEOS

In the French patent application No. FR 2 929 024, a way of applying the general process to the non-programmable contents delivered by Internet, included in an HTML page of a browser, is described.

### 3-1 FIRST EMBODIMENT

### Display of Online Images

The invention, according to an embodiment, consists in including the content in a container that is itself programmable like a plug-in Silverlight of Microsoft or AIR of Adobe, and further building dynamically into the plug-in the proper console for recovery of the content as a function of the current rights. This embodiment, in terms of the image, results in dynamically building the display that recovers the pages of the document, only when the rights permit it. This mode is particularly suited to online page-flipping and more generally to online consulting within a limited time. FIG. 3 shows a dynamically generated multimedia reader. The advantage of the process is that it does not oblige the purchaser to download a display console, because the display console is created dynamically if the current rights permit it.

In this embodiment consisting in page-flipping an online document, the images of the pages are included in a .zip file; the representation of the images is separate and consists of layouts in layers (canvas), one layer per image, superposed and transparent, except for the page being read. The other graphic objects, such as gauge, and movement buttons are added to the main layer dynamically by evaluation of the scripts representing them. The images, the layers and other graphic objects are downloaded by the plug-in inscribed in the XHTML page, only when the current rights permit it. To prevent the images from appearing in the clear in the receiving buffers, the images are transformed by a reversible masking matrix. The decrypting matrix is encrypted with the server key and sent with the images. After the loading of the images, it is sent back to the control server by AJAX or equivalent protocol, which decrypts it and returns it in the clear, which unmasks the images.

Another embodiment relates to the contents accessible in “embedded” mode on an external physical medium, disks, CD-ROM, USB keys, etc.: texts, images, music, videos, etc., and the contents delivered continuously over http protocol. This mode consists in including the passive object, for example in MP3, SWF, AVI, or FLV (Flash Video of Adobe) format, in an XHTML page that serves as a generic model. The object can be the URL of an external source on the network, or be included in a container with the XHTML page.

Other embodiments of the invention apply the system described to the EPUB format for the digital book.

### 3-2 SECOND EMBODIMENT

### “Continuously Distributed Contents”—FIG. 4

This is the case of the publishing of an XHTML page by the online bookstore for distributing secure documents; the online bookstore is described in the French patent application No. FR 2 929 024.

According to this mode, the content is loaded into the storage unit of the reference documents of the bookstore, and then configured with the consulting restrictions. For the purpose of publishing, said content is referenced in an XHTML page written in script language, for example PHP, which serves as a generic model and contains zones provided to receive objects such as the image, sound, and video, plus the title, information relating to the intellectual property rights and as many comments as needed. The sound and video can be recovered by the call to a flash reader included in the page, or a “mediaplayer” reader, or by the call to another recovery application according to the editor (see FIG. 3). This constitutes the processes shown in the box K1 of FIG. 4. There is a generic model page by type of content, for example a page containing an “application/x-shockwave-flash” for FLV.

The page also contains the clause intended to receive hereafter the unique identifier of the page as a parameter.

In PHP,$idUnique=$_REQUEST[“idUnique”]

and dynamic parameters such as the identification of the authorized reader, for which the following will be added:

In PHP, $name =$_REQUEST[“name”] and
$password = $_REQUEST[“password”]

The idea of unique identifier is described in the international application WO 2007/135281. In an open system, the unique identifier comprises the unique identifier of the editor and the unique identifier assigned in its domain by the editor.

The page further contains the “supervisor” that consists of JavaScript scripts:
A—The call to the decode function in the body tag <body on Load=“decode(unique_identifier)”>. decode(unique_identifier) can also be assigned to the load event of the window object. In this case, there is no need to modify the <body> tag.
B—The link to the external JavaScript script control.js containing, among others, the decode function and the management functions of the DOM (Document Object Model): <script src=‘control.js’type=‘text/javascript’></script>
C—A zone provided to receive the reference to the content, for example the source attribute “name of the content”

The model page is then recopied, renamed (box K2). If the FLV content is “Chant du Départ”, the recopied page is called “Chant_du_Départ.php.” The zones of configuration are filled in.
Then, the delivery server generates the server key with which it encrypts “Chant_du_Départ.php” (K21), for example by performing a “hash” of the <body>, and then by using this result plus a random seed to encrypt the content of each paragraph <p> and optionally the “digest” of the paragraph. It encodes everything in base64. It can further encrypt it a second time at the level of the <body>. The encryption algorithm is at the option of the delivery server; the server key is stored in the control server with the other parameters of said document (K22).

The passive object is also encrypted in AES or another symmetric key with the content key, generated by the delivery server from an alea or from a “hash” of the content, and stored on the control server with the other parameters and constraints of the document.

From the generic model, there is therefore obtained a “Chant_du_Départ.php” page, provided with a JavaScript supervisor, encrypted, containing a reference to the “Chant_du_Départ.flv” content, ready to receive its execution context when a purchaser will order it.

Then, the page is published (K3), that is to say that it is recorded in the storage unit of the reference documents of the delivery server 10A, where it appears to the public referenced by the URL of the type: https://server/welcome.php?title=Chant-du-Départ.php

Chant du Départ is then ready for distribution.

### 3-1 RECOVERY OF AN XHTML PAGE PREVIOUSLY PUBLISHED BY THE ONLINE BOOKSTORE FOR DISTRIBUTION OF SECURE DOCUMENTS

The URL https://server/welcome.php?title=Chant-du-Départ.php can be inserted in any HTML page, particularly in the pages of an order/delivery web server 10A, FIG. 4.

To obtain a document, the customer selects the URL displayed by the list W1 of the console (button W10, FIG. 8, diagram of the console) (box K10).

The link is activated; the php script creates:
D—a delivery environment intended for the backoffice processing of the orders (payment, management of stocks, statistics, etc.),
E—in the rights database of the control server, an environment containing all of the information relating to the Chant_du_Départ content to be delivered: title, name of the file (Chant_du_Départ.php), publishing constraints, token, keys, counters and other dynamic control data. This environment is referenced by a unique identifier (K20).

And the php script creates the linkto the environment of this instance: https://server/Chant_du_Départ.php?p1=(unique_identifier&p2=param_control), where param_control contains the control parameters (for example, a token, the name of the file, etc.); the whole is encrypted with the server key (K23). The link is inscribed in the list W2 of the console. The external license is inscribed in the zone W3.

The following stages (K24) to (K31) are repeated at each request for recovery of the content.

The link selected from the list W2 (K24) by the button W12 is signed by the console with its key (K25). It becomes https://server/Chant_du_Départ.php?p1=console_identifier&p2=code((unique_identifier&p2=param_control), console_key),

The link is activated (K26).

Then the script Chant_du_Départ.php:
F—decrypts the control parameters with the console key, and then the server key. In case of a difference between the stored parameters and the decrypted parameters, fraud is presumed and the request is abandoned
G—additional information is requested if need be (see Assignment of a document to a person duly identified).
H—It constructs the HTML page, instance of Chant_du_Départ.php referenced by the unique identifier, and it delivers it to the console W4 (K28). Upon receipt of the “load” event (K29), the decode(unique_identifier) function is called upon (box K30). It verifies the current rights for the unique identifier by AJAX request or equivalent protocol of the type https://server/control.php?p1=unique_identifier, control.php
I—updates the counters, dates, and other control data.
J—returns to the console an open ticket in the XML format, signed by the control server, which is an authorization for recovery of the document, or a refusal according to the current rights, as defined in the French patent application No. FR 2 929 024. This ticket contains at least the unique identifier of the document, the date and time, the validity, the validity period, and supplementary parameters such as the current rights, also called local license.

The box K28 indicates that the open ticket is loaded into the encrypted local memory of the console (in proprietary language).

The box K29 indicates that according to the validity of the open ticket, the instance Chant_du_Départ.php?p1=unique_identifier can be decrypted.

The decrypted function ( ) performs the decryption of the XHTML page in the following way:

The box (K30) indicates that there is no local decryption, but that each paragraph content <p> obtained by innerHTML property is sent successively to the convert.php script executed on the control server, by AJAX or another equivalent protocol in secure session, which performs the decryption of these paragraphs with the server key stored on the control server with the other parameters of said document (K31), and resends them in the clear to said document. The content of each paragraph <p> obtained by the innerHTML property is then replaced by the decrypted content. These functions use the API (Application Programming Interface) of the DOM (Document Object Model) to obtain all of the contents of all of the paragraphs, and to replace them with their value in the clear. Each content <p> is accompanied by the unique identifier of the instance of the document for the purposes of session control (see below).

A basic example of decryption of an XHTML document in JavaScript, according to the stated principles:

```
Function decryptElement(document, xhr1, ident) {
// xhr1 : XMLHttpRequest
// ident : unique identifier
    var v = document.getElementsByTagName(‘p’);
  for (var i=0; i <v.length; i++) {
    if(v[i].hasChildNodes( )) {
        var str = v[i].innerHTML; //str is the content of a paragraph p
    xhr1_object.open(‘POST’, ‘convertp.php’, false); // call of the
remote function of decryption
  xhr1_object.setRequestHeader(‘Content-Type’, ‘application/x-;
    www-form-urlencoded’) xhr1_object.send(‘p1=’ + ident +
‘&string=’ + str);
    if(xhr1_object.readyState == 4 && xhr1_object.status == 200)
var strret = xhr1_object.responseText;
    v[i].innerHTML=strret;
      }} // for
    }
```

These process steps unmask the text of the page and the call of the source of the object mpeg, mp3, jpeg, etc. and must be completed by the decryption of the object. To do this, a content key is used to decrypt in memory and “on the fly” the successive fragments received. This content key has been previously generated for said document (see earlier paragraph), stored in its execution context with the other parameters and constraints, and transmitted to the console encrypted by the server key with the document.

In the control server, to prevent diversions, it is important to make sure at the time of decryption that the requests come indeed from internal demands, and that the authorizations are always in force during the entire decryption phase.

To make sure that the authorizations are always in force during the decryption, a solution consists in framing the operations between the identification of the document and the end of the decryption of said document by a server session assigned to the unique identifier, for example in php:

as long as the following is true

($_SESSION[‘unique_identifier’]==standard_unique_identifier), $_SESSION[‘unique_identifier’] being initialized by the initialization function Decode(unique_identifier), and destroyed at the end of the decryption.

Other solutions exist for the responsibility of the control server, which are known and are not part of this application.

The encrypted link received in stage (K24) can be exchanged and multiplied on any type of platform that supports the prerequisites in the specialized console.

### Assignment of a Document to a Person Duly Identified

The document can have as a constraint to be able to be read only by a person duly identified/authenticated. For example, the constraint is represented by the name and password of a person appearing in the control record of a document. In this case, said document must obtain the identification data. In one embodiment among others, the document requires the entry of the identification/authentication data by a form requesting a name and a password. To do this, one method consists in including an invisible layer in the <body> of the model page, by

<body><div id=“main” style=“display :none”>all_the_body</div></body>,
and the model page is completed with another invisible layer containing the form for entry of identification data
<div id=“ident” style=“display :none”>entry form</div>.

In the stage G described above, the document presents the entry form if an identification is required and if the current rights are valid, while rendering visible the layer that contains the entry form (display :block). The values of the fields of the identification form, for example name and password, are entered and then returned to Chant_du_Départ.php by the function javascript :ident(name, password), associated with the validation button of the form, which sends them by AJAX to the control server where they are verified. As long as the identification is not performed, the form is shown.

When the identification is satisfied, the result is returned and recovered in JavaScript or owner language by the document, which renders invisible the layer for entry (display :none), while the main layer “main” is rendered visible and decrypted.

Example of code in JavaScript fulfilling the visible/invisible function:

```
    var ident = document.getElementById(‘ident’);
        ident.style.display=‘none’;
    var main =document.getElementById(‘main’);
        main.style.display=’block’;
and then passage to stage I.
```

The identification/authentication procedure can be made as complex and demanding as is desired. It is seen that the process makes it possible simply to assign a content to a person in a very complete way.

Another method consists in that the supervisor of the document dynamically constructs said XHTML form, and associates with it the function of verification of the entry in stage G (box K21).

This process can be applied to any constraint requiring a supplementary entry of data during the call of the document.

The exchanges must be done within a session attached to the instance of the document, of the secure https type.

### 4—Third Embodiment

### “EPUB Format”

This is a packaged format gathering together the contents, their structures, their presentations, and the supplementary data for publishing. The pages that contain texts, images, multimedia objects, hypertext links, and the structures are in the XML format represented in memory by a DOM (Document Object Model) tree in the environment of the browsers.

To better control the documents, the contents are rendered in the private environment of the console, a “widget,” either in an execution engine on the desktop (Adobe, Microsoft), or in an execution engine of the browser (Opera widget manager for mobile terminals).

The portability of these widgets depends on the portability of the execution engines on which they rely, and can be very broad.

To publish a document in the controlled EPUB format, follow the following stages already seen in the embodiments 2 and 3:

For a document ordered by a reader, first create the control record in the external database fixing the user rights relating to said instance. Store the unique identifier with the control record.

Unzip the EPUB packet, and encrypt each XML page that it contains (in general one page per chapter); that is to say encrypt the essential elements thereof, such as, for example, all of the contents of the paragraphs between the tags <p> and </p>. The entire content of the tag <body> can also be encrypted. Encode the encrypted contents in base64. The encryption key is recorded in the rights database, with the other control data of the digital content, such as the expiration date, or the daily authorized reading frequency. The images and other passive contents are encrypted separately with a second key, the content key obtained as in mode 2.

Recover the unique identifier of this record and inscribe it in the clear in the metadata of the EPUB document with the control parameters in encrypted form using the server key. Also store the identification request, so that the document is identified by the control server, for example in <dc:creator opf:role=‘oth’ https://server/ident.php?p1=unique identifier&p2=control paramident.php receiving the unique identifier and the control parameters that are re-encrypted with the console key obtained by the installation process of the software device. Rezip the modified files and store the document in this unreadable form on the delivery server.

Sign the zipped packaged document.

Deliver the packaged document in this form to the customer by downloading.

The customer records the document in this form in his local file system. The document is unreadable in this form.

The customer who receives the document can read it only in a “reader” of widget technology that has the right to perform inputs/outputs in the local file system. (See FIG. 8.) This reader takes the form of a console that presents the EPUB accessible documents (W1). By the button W10, the customer records the instances of the purchased documents and presents them in list form (W2). The rights relating to the instances appear in the zone W3.

By the button W12, the customer asks to read a work selected from W2. The mere opening of the EPUB document from the console launches a series of actions to find the input file of the EPUB document in the zip, “container.xml” housed in the META-INF directory, and then the OPF file that contains the structure of the document and the sequence of the pages, and performs the loading of the metadata in XML format.

Following the loading of the metadata, the identification/authorization procedure for reading is found and launched, and sends to the control server by AJAX (or another equivalent protocol) a request containing the unique identifier, stored in the metadata. https://server/ident.php?p1=console_identifier&p2=code(unique_identifier&p2=control_param), console_key)

If the script ident.php does not recognize the control parameters (the decrypted parameters must be identical to the stored parameters), the identity of the console is usurped and the script does not return anything to the console. In the opposite case, it verifies the current rights for the unique identifier.

The control server verifies the origin of the request by recalculating the control parameters, and returns the open ticket. If the authorization is granted, the paragraphs in the XML format are loaded one by one into the display console. The decryption of each page is triggered on receipt of the “load” event of each XML page (generally a chapter). The contents obtained by the innerHTML property of each element p (or body) of the loaded page are sent by remote request to the control server that returns them in the clear if the current rights for said document permit it. These elements that have become clear replace the encrypted elements.

The image and video contents, when they exist, are processed as in the description 3.

The link between the document and the control server must be a secure session of the https type to be assured of the identity of the server and to maintain the confidentiality of the exchanges.

### 5—PARTIALLY CONNECTED MODE

Following the identification/authorization request contained in the secure document sent by the console, the console records the response of the control server: the “open ticket” containing the current rights relating to said document (see French patent application No. FR 2 929 024) comprising the unique identifier, the control parameters for the publishing, the validity period of the ticket, the date and time, in the permanent encrypted local memory assigned to each widget. This open ticket takes the form of an XML string that is evaluated by the console on the terminal, producing an object attached to the secure content.

The ticket is stored in the permanent encrypted local memory of the terminal. Also added to the ticket is a time counter, initialized by the validity period, and periodically decremented by a function referred to as a timer. A short time before the counter becomes zero, the console can warn the user, so that he extends his disconnected session or not.

The console also records all of the elements <p> to the extent that they are decrypted in the encrypted permanent mass storage associated with the console. These elements as a whole constitute the encrypted cache of the EPUB document. These elements are therefore clear only for the time of the display. The AES encryption (or another system of symmetric encryption) of the elements <p> is done with a key pertaining to each console on a given terminal (an alea+unique identifier of the console).

The technology of the widgets used by the console has this distinctive feature that the local memory assigned to the console can be written, read and re-read only by the console, software application duly signed, and it cannot be accessed by any other program.

Hereafter, if the terminal is disconnected from the network and the document cannot verify the current rights in the external database, said document will go to seek the information in the local encrypted memory (the open ticket), and, if the rights constituting the “partially connected” license appearing in the open ticket permit it, will recover the document in the clear, thanks to the paragraphs <p> stored in the encrypted permanent mass storage, which constitute the encrypted cache.

To prevent the document from being read on an uncontrolled number of terminals, it is sensible to restrict the document to a few consultation occurrences per day, for example 2 or 3. In this specific case, it will be possible to have only 2 or 3 consoles able to recover the document, for a daily partially disconnected mode.

Considering the possibility for the reader to modify the date and time on the PCs, it is preferable to trust the time passed rather than the dates.

### 6—DISCONNECTED MODE

The publishing system is directed to facilitate the consultation of a large number of digital works of all types, and of all origins, without purchasing a permanent license.

Nevertheless, some customers will want to purchase the permanent right to consult a document. To do this, if the distributor authorizes it on a fixed number of terminals as a parameter of the document, stored on the control server with the other parameters, the following procedure will be applied to the partially connected mode:

At any time of the consultation period that is provided, the customer can make a request of permanent assignment of the consultation right to the control server from the console. The control server sends to him in response a permanent open ticket, comprising the permanent license, including an infinite timeline, for example by replacing the timeline with 99999999, and subtracts 1 from the number of terminals that support a permanent authorization, which is merely the number of authorized daily consultations of the document. Hereafter, the procedure will be able to be repeated several times until the number of terminals (that is to say the number of authorized daily consultations of the document) is zero. Then, the control server blocks any new request for authorization addressed to it on this unique identifier, putting an end to roving consultation of the document in connected and partially connected modes.

Each open ticket with a 99999999 timeline is recorded on a terminal supporting the prerequisites, at the choice of the user. These eterminals hosting the console will be henceforth the only points where the document will be able to be consulted. Actually, since the encryption of the elements <p> is done with a key pertaining to each console on a given terminal, the EPUB document is no longer transportable; it is “fixed.”

Such a right for consultation of the documents can have a longer service life than the terminals that they support. For example, if the document is authorized to be recovered on 3 terminals, the customer can attach this document to two terminals, his PC and his mobile telephone, for example, and keep the right to consult it while roving since it leaves him with one attachment right (one reading occurrence per day). Several years later, when he will change his PC or mobile telephone, he will be able to request an extension of his contract, since he will always have the right to be connected to the control server, and to use this last right to attach the document to a new piece of equipment.

The connected and disconnected modes of a document are diagrammed in FIG. 6 in which the various boxes are made explicit below:

The box K67 indicates the sending of the open ticket. The box K61 indicates the initialization and the storage of the open ticket in the local memory.

The box K71 indicates the sending of the request for authorization of the total connected mode.

The box K72 indicates a positive response to the request.

The box K73 indicates the initialization for the sending to the control server of the paragraphs.

The box K74 indicates the operation for decryption of the paragraphs sent in the clear. The box K75 indicates the storage of the paragraphs in the local encrypted mass storage. The box K80 indicates the local recovery of the paragraphs stored in the local encrypted mass storage.

### 7—FOURTH EMBODIMENT

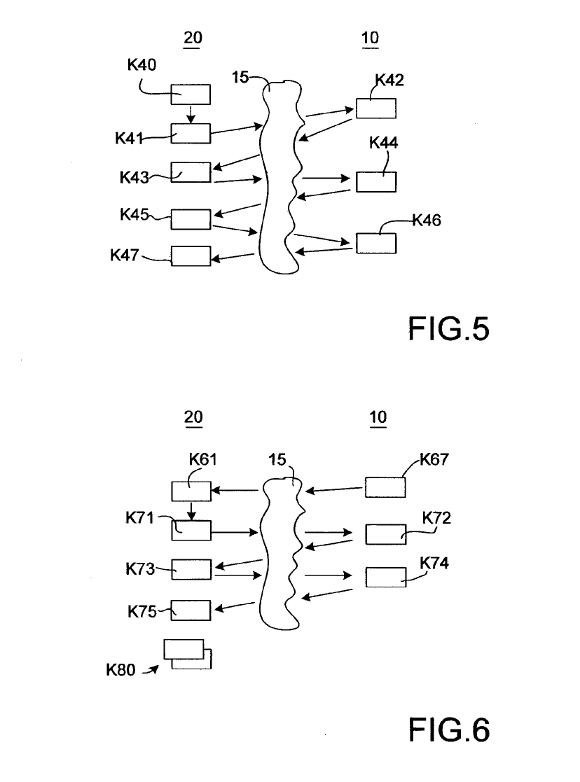

### “Embedded Contents”—FIG. 5

The contents are not recovered online, but are packed into a container, optionally with accompanying files, the whole being recorded on a disk, CD-ROM, USB key, etc. They can be in keeping with the EPUB format (see the chapter concerning the EPUB format), or more simply comprise at least one XHTML page, the plug-in that contains the supervisor and the content, the whole being referenced as an object in the tag <OBJECT> of the page. It also contains the unique identifier and the request for initialization/identification of the document, for example in the tags <META NAME=“distribution”/> and <META NAME=‘identifier-URL’/>. The supervisor acts following the receipt of the “load” event by the function decode(unique_identifier) as in the embodiment 2.

The content key is taken with the document, encrypted by the server key associated with the unique identifier.

t. [sic] After an initialization phase (box K40) FIG. 5, which verifies the signature of the distributor, the plug-in executes the identification request (box K41). In return, the control server sends the “open ticket” (see EPUB).

If the current rights permit it, the content key is decrypted (K42), which makes it possible to decrypt the content “on the fly” and in volatile memory. The boxes (K43) (K44) (K45) are the stages for deciphering the paragraphs <p>; (K45) (K46) (K47) relate to the decryption of the image or multimedia contents.

The multimedia contents (box K47), for example “Chant_du_Départ.mp3”, are recovered by a reader (player) that is included, which accepts on entry the memory string obtained by the call of a function, of the type “recovers(Chant_du_Départ.mp3)” that decrypts the content “on the fly” in volatile memory with the content key.

If the content key is authorized, by the open ticket, to be stored in the encrypted permanent memory of the console, the content can be recovered in partially disconnected mode, or permanently disconnected mode (see the procedure to be applied in the chapter on the EPUB format).

Such a document can travel on any type of medium, CD-ROM, USB keys, networks, in an unlimited number of copies, and can be recovered on all platforms that support the widget console and the appropriate player, while remaining restricted by its associated rights.

### 8—EXAMPLE OF EMBODIMENT

In an online bookstore, which sells printed works, it is desired to add the sale of works by downloading of all types: books, music, video, etc. The distribution process described in this document makes it possible, and guarantees to the editors that the intellectual property rights are respected.

The “loading” portion of the works comprises the transfer of the works in the storage unit of the reference documents on the delivery server, then the encryption and the reference of said works, and the displaying to the public by the order server, where a “page-flipper” makes it possible for the customers to reveal all or part of the work for a reasonable price.

To purchase, the customers access the publications from a specialized console if it involves an XHTML or multimedia document by continuous downloading or by streaming. The delivery server delivers a link referencing the encrypted document for the purchaser, which backs it up, and then recovers it in the console/widget.

If it involves an “EPUB” book, this book will be downloaded on the terminal where the reader records it in encrypted form. It is decrypted by a process previously mentioned that causes the console and the control server to intervene.

These readings or renderings are still operating in connected mode, but also function in partially connected and disconnected mode if the distributor authorizes it.

The distributor can also send the works in PDF format that is controlled by JavaScript scripts, which can be recovered in the console.

The publisher can also send the contents to the customers on a physical medium (USB key, CD-ROM, etc.).

The PDF, XHTML documents, and the EPUB books dealt with by the process are able to be copied multiple times, able to be exchanged, on any platform supporting the prerequisites, under the conditions previously mentioned.

1-11. (canceled)

12. A process for controlled distribution of XHTML documents comprising the steps of:
a delivery server (10A) referencing a dynamicXHTML document (50),
user rights being associated with the XHTML document (50, w20), the delivery server storing a script (Z2) with a function of a supervisor agent of the XHTML document (50), the script (Z2) containing dynamics of the XHTML document (50), the script called following an end-of-loading event sent by the XHTML document (50) after completing the reception on a receiving terminal (21), and storing a digital document (Z1) and the XHTML document (50) in a storage unit of the delivery server (k2); and
publishing the dynamic XHTML document (50) by inserting a URL of the XHTML document (50) in a page of a order/publication server (k3).

13. The process according to claim 12, wherein,
the customer activates a URL of the page containing the URL of the XHTML document in order to have the delivery server execute the page (k10), and
when executing the page, the delivery server generates i) an instance of the XHTML document (w20) containing a unique identifier (Z3, k20, id1, id2), and ii) a delivery environment associated to the unique identifier (id1, id2) in a rights database (w22) hosted by a control server (w21) containing a publishing context including a title, a name of the file, publishing constraints, tokens, keys, counters and other dynamic control data, and iii) creates a link to an environment context of the instance (w25, w26, w27).

14. A process for encrypting/decrypting the XHTML document according to the claim 13, comprising the further steps of:
the delivery server (10A) generating a symmetric encryption key (K21);
the delivery server (10A) encrypting the XHTML document (50), element by element, with the generated symmetric encryption key (K21), the elements being an innerHTML property of each structuring XHTML object;
further coding results of the element by element encryption in base64 to support exchanges on http and http variants;
activating the link to the instance of the XHTML document containing the unique identifier (k26), causing the XHTML document to be delivered to the terminal (k28, w25, w25, w27), wherein,
the results of the encryption are decrypted by the control server (10B), when the current user rights for the unique identifier (id1, id2) concerned permit the decryption of the results(w25, w27),
an unmasking is obtained by the script with the function of the supervisor agent of the XHTML document, the script triggered by the event end of loading of the XHTML document on the receiving terminal (k29, w25, w26, w27), the script sending to the control server the unique identifier of the XHTML document (id1, id2), with the encrypted values obtained from the innerHTML property of the structuring objects, by AJAX or an AJAX-equivalent protocol (K30),
the control server, having access to the symmetric encryption key stored in the publishing environment of the instance, relates to the unique identifier (K22, id1, id2), when the user rights permit decryption, returns the values obtained from the innerHTML property of the structuring objects, decrypted by the symmetric key, to the caller script (K31),
the caller script (K31) replaces the innerHTML properties of said objects with the decrypted values in the clear thus unmasking the XHTML document (50),
exchanges between the script and the control server being done on a secure http session, and
the XHTML document being rendered on a console (20) constructed in a browser or in an application on a desktop, the memory of the console being isolated and out of reach by other applications, and supporting at least input/output functions.

15. The process according to claim 14, comprising the further step of:
for each consultation by a caller, delivering the digital document (Z1) attached to the XHTML document to the receiving terminal (20),
wherein the digital document has been encrypted with a content key by the delivery server,
wherein said content key is attached to the XHTML document,
wherein the script with the function of the supervisor agent, at an end of the loading of the XHTML document, obtains the content key from the control server by AJAX protocol or AJAX-equivalent protocol, when the current user rights for the XHTML document referenced by the unique identifier permits decryption of the XHTML document.

16. The process of claim 15, comprising the further steps of:
assigning stages to verify supplementary data required by the XHTML document (50), to assign a duly-identified customer to the digital document, the assigning stages comprising
i) introducing identification data of said customer into the environment of the instance of the XHTML document (50),
ii) adding to the XHTML document a form for entry of identification data into a layer,
iii) rendering visible to the customer the layer containing the identification form when an identification is required as long as the valid data are not furnished,
iv) verifying the identification data by sending the said identification data by AJAX or variants to the control server, which returns the result correct or not correct of the verification, and
v) rendering visible the XHTML document when the result of the verification by the control server is correct.

17. The process of claim 16, wherein the supervisor of the document dynamically constructs the identification form, and associates with it the function of verification of the identification data

18. The process of claim 14, wherein,
the control server responds to a request for consultation issued by the XHTML document with an open ticket recapitulating the current rights for said XHTML document (k67), the open ticket being stored on the receiving terminal in a local encrypted memory (k61), and read by script functioning as the supervisor agent when interrogating the control server is not available (k80), and
the XHTML document is decrypted (k80) according to the current rights stored in the open ticket, the decryption of the XHTML document being done by unmasking, from a cache containing the innerHTML properties in the clear of the structuring XML objects decrypted in a preceding online session with the control server (k71, k72, k73, k74, k75), the rights allowing the consultation of the XML document, without verification by the control server, during a fixed period or permanently.

19. The process according to claim 18, wherein the cache is itself stored on the receiving terminal (20) in a permanent encrypted memory, attached to the terminal, authorizing the recovery of the XHTML document according to the rights contained in the open ticket.

20. The process according to claim 19, wherein,
a digital book is in EPUB format,
the digital book comprising a plurality of elementary XHTML pages, with or without images and multimedia contents, compressed in an archive, and supplementary information in a form of XML metadata, the supplementary information including at least one selected from the group consisting of i) an author of the digital book, ii) a publisher of the digital book, and an ISBN of the digital book,
the process includes adding to said metadata a field containing a request for identification/authorization comprising a link to the control server (10B) with the unique identifier of the digital book as parameter, and
the book is encrypted page by page and element by element with a symmetric key and delivered to a console,
the link to the control server is called while reading the metadatas and returns the authorization to decrypt or not the book, and
the book is recovered in a console (20) supporting at least input/output functions, when the current rights authorize recovery in the console by decrypting each page and inside each page each structuring element by the control server with the symmetric key associated with the unique identifier.

21. A process for distributing a passive document free of programming elements, according to claim 19, comprising the further steps of:
providing the passive document in an XHTML document comprising a programmable plug-in,
wherein the programmable plug-in is referenced by a unique identifier (k1),
wherein the programmable plug-in controls the passive document, and recovers the passive document when current rights authorize the rendering of the passive document within the XHTML document (k29); and
a supervisor of the programmable plug-in dynamically constructing a proper console for recovery of the passive document when current rights authorize recovery.

22. System according to claim 21, wherein,
requests and recoveries of the digital document are performed within a console,
the console verifying integrity and origin of the digital document to be recovered by a signature of the XHTML document, and preventing usurping of the recovery device by a software supervisor associated with the XHTML document, which verifies an identity and an origin of the console.

23. Process according to claim 21, wherein,
the document comprises at least one XHTML page that contains the supervisor and the content, being referenced as an object in the tag <OBJECT> of the page, the unique identifier and the request for initialization/identification of the document (k41),
the content key is taken with the document, encrypted by the server key associated with the unique identifier,
when the current rights permit decryption (k40), the content key is decrypted (K42) by the control server, receiving the encrypted content key, and returning the content key decrypted, which makes possible to decrypt the content on the fly and in volatile memory (k43)(k44)(k45), and
the multimedia contents (k46)(K47) are recovered by a reader that is included, which accepts on entry a memory string obtained by the call of a function that decrypts the content on the fly in volatile memory with the content key.

24. The process according to claim 20, comprising the further step of:
during an initial dialog with the control server, at installation of the console, the console (20) becomes known to the control server by the console receiving a unique string from the delivery server, the unique string being used as a unique identity of the console, the unique string associated with a symmetric key used to encrypt messages between the console and the control server.
